(19) United States
(12) Patent Application Publication
(10) Pub. No.: US 2006/0080467 A1
(43) Pub. Date: Apr. 13, 2006

(54) Apparatus and method for high performance data content processing

(75) Inventors: Stephen Gould, Queens Park (AU); Ernest Peltzer, Eastwood (AU); Sean Clift, Willoughby (AU); Kellie Marks, McMahons Point (AU); Robert Matthew Barrie, Double Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., East Sydney (AU)

(21) Appl. No.: 10/927,967

(22) Filed: Aug. 26, 2004

(51) Int. Cl. G06F 15/16

(52) U.S. Cl. 709/250

(57) ABSTRACT

Incoming data streams are processed at relatively high speed for decoding, content inspection and classification. A multitude of processing channels process multiple data streams concurrently so as to allows networking based host systems to provide the data streams—as the packets carrying these data streams are received from the network—without requiring the data streams to be buffered. Moreover, host systems processing stored content, such as email messages and computer files, can process more than one stream at once and thereby make better utilization of the host system's CPU. Processing bottlenecks are alleviated by offloading the tasks of data extraction, inspection and classification from the host CPU. A content processing system which so processes the incoming data streams, is readily extensible to accommodate and perform additional data processing algorithms. The content processing system is configurable to enable additional data processing algorithms to be performed in parallel or in series.

### FIELD OF THE INVENTION

The present invention relates to integrated circuits, and more particularly to content processing systems receiving data from a network or filesystem.

### BACKGROUND OF THE INVENTION

Deep content inspection of network packets is driven, in large part, by the need for high performance quality-of-service (QoS) and signature-based security systems. Typically QoS systems are configured to implement intelligent management and deliver content-based services which, in turn, involve high-speed inspection of packet payloads. Likewise, signature-based security services, such as intrusion detection, virus scanning, content identification, network surveillance, spam filtering, etc., involve high-speed pattern matching on network data.

The signature databases used by these services are updated on a regular basis, such as when new viruses are found, or when operating system vulnerabilities are detected. This means that the device performing the pattern matching must be programmable.

As network speeds increase, QoS and signature-based security services are finding it increasingly more challenging to keep up with the demands of the matching packet content. The services therefore sacrifice content delivery or network security by being required to miss packets. Furthermore, as sophistication of network and application protocols increase, data is packed into deeper layers of encapsulation, making access to the data at high speeds more challenging.

Traditionally content and network security applications are implemented in software by executing machine instructions on a general purpose computing system, such as computing system 100 shown in FIG. 1. The machine instructions are stored on disk 125 and loaded into memory 120 before being executed. The CPU 105 fetches each instruction from memory 120, decodes and executes the instruction, and writes any necessary results back to memory. Modern processors have pipelines so that fetching of the next instruction can begin while the previous instruction is still being decoded. The data being processed may come from memory 120 or from a network through the network interface 130. All peripheral devices communicate over one or more internal buses 135. The CPU 105 thus manages the processing and movement of data between disk 125, memory 120, etc. CPU 105 communicates with network 135 via network interface adapter 130. CPU 105 is shown as including a control unit 140 which performs the tasks of instruction fetch, decode, execute and write-back, as is known to those skilled in the art. The instructions are fetched from memory at the location pointed to by the program counter 150. The program counter 150 increments to the next address of the instruction to be executed. The memory management unit (MMU) 160 handles the task of reading data and instructions from memory, and the writing of data to memory. Sometimes data and instruction caches are used to provide optimized access to the larger system memories.

Such traditional systems for implementing content and security applications has a number of drawbacks. In particular, general purpose processors, such as CPU 105, are unable to handle the performance level required for state-of-the-art content filtering systems. Moreover, sharing of vital resources such as the CPU 105 and memory 120 causes undue bottlenecks in content and network security applications.

### BRIEF SUMMARY OF THE INVENTION

In accordance with the present invention, incoming data streams are processed at relatively high speed for decoding, content inspection and content-based classification. In some embodiments, a multitude of processing channels process multiple data streams concurrently so as to allow networking based host systems to provide the data streams, as the packets carrying these data streams are received from the network, without requiring the data streams to be buffered. Moreover, host systems processing stored content, such as email messages and computer files, can process more than one stream at once and thereby make better utilization of the host system's resources. Therefore, in accordance with the present invention, processing bottlenecks are alleviated by offloading the tasks of data extraction, inspection and classification from the host CPU.

In yet other embodiments, the content processing system which so processes the incoming data streams, in accordance with the present invention, is readily extensible to accommodate and perform additional data processing algorithms. The content processing system is configurable so as to enable additional data processing algorithms to be performed in a modular fashion so that it can process the data by multiple algorithms in parallel or in series. For example, in one embodiment, where inspection of a compressed data stream may be required, the apparatus may use two processing algorithms in series, one of which processing algorithms decompress the data, and another one of which processing algorithms inspects the data for a predetermined set of patterns.

### BRIEF DESCRIPTION OF THE DRAWINGS

FIG. 1A shows a general purpose computer system with CPU, memory, and associated peripherals used for data processing.

FIG. 2B is an internal block diagram of a central processing unit (CPU) as known to those trained in the art.

FIG. 2 is a high level block diagram of the content processing apparatus for decoding, inspecting and classifying data streams as disclosed herein.

FIG. 3 shows the packet structure used by one embodiment of the invention.

FIG. 4A shows sequential data processing.

FIG. 4B shows parallel data processing.

FIG. 5A is a flowchart for processing packets by one embodiment of the invention.

FIG. 5B is a flowchart of the context retrieval for one embodiment of the invention.

FIG. 5C shows flowcharts for the processing of Open, Write and Close command packets by one embodiment of the invention.

FIG. 6 is a first exemplary data flow.

FIG. 7 is a second exemplary data flow.

FIG. 8 is a third exemplary data flow.

FIG. 9 is a fourth exemplary data flow.

FIG. 10 is a fifth exemplary data flow.

FIG. 11 is a sixth exemplary data flow.

### DETAILED DESCRIPTION OF THE INVENTION

In accordance with the present invention, incoming data streams are processed at relatively high speed for decoding, content inspection and content-based classification. In some embodiments, a multitude of processing channels process multiple data streams concurrently so as to allows networking based host systems to provide the data streams, as the packets carried these data streams are received from the network, without requiring the data streams to be buffered. Moreover, host systems processing stored content, such as email messages and computer files, can process more than one stream at once and thereby make better utilization of the host system's central processing unit (CPU) and other resources. Therefore, in accordance with the present invention, processing bottlenecks are alleviated by offloading the tasks of data extraction, inspection and classification from the host CPU.

In yet other embodiments, the content processing system which so processes the incoming data streams, in accordance with the present invention, is readily extensible to accommodate and perform additional data processing algorithms. The content processing system is configurable so as to enable additional data processing algorithms to be performed in a modular fashion so that it can process the data by multiple algorithms in parallel or in series. For example, in one embodiment, where inspection of a compressed data stream may be required, the apparatus may use two processing algorithms in series, one of which processing algorithms decompress the data, and another one of which processing algorithms inspects the data for a predetermined set of patterns.

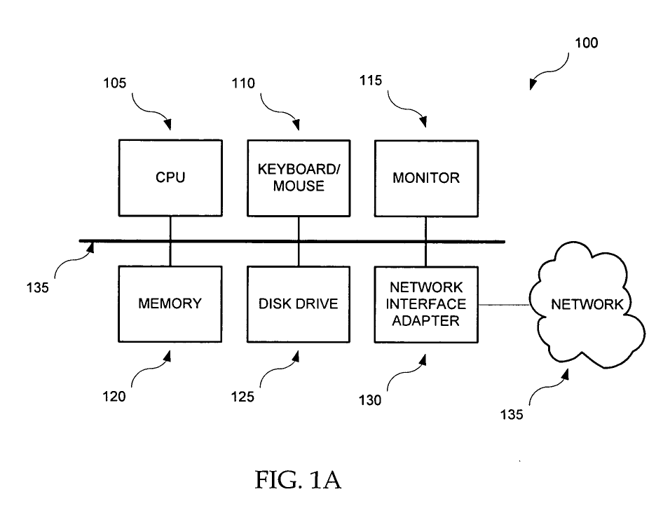

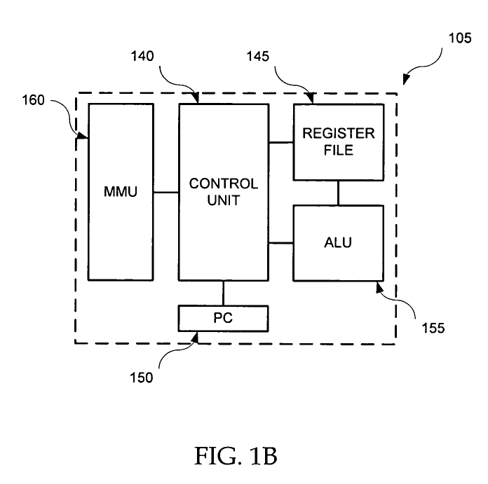

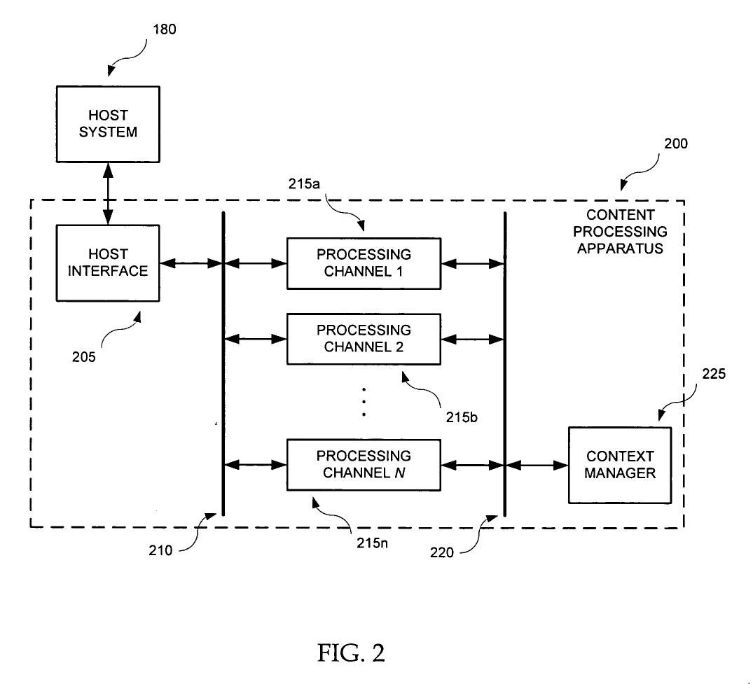

FIG. 2 is a simplified high-level block diagram of a content processing system 200, in accordance with one exemplary embodiment of the present invention. Content processing system 200 is coupled to host system 180 via the host interface 205 from which it receives the data stream it processes. It is understood that a data stream refers to a flow of data and may include, for example, entire data files, network data streams, single network packets, e-mail messages, or any self-contained predetermined sequence of bytes. Receive data is processed as quantized packets in one or more of a multitude of processing channels 215a, 215b, 215n. The quantized packets, which include commands and data as discussed further below, are sent from the host system 180. As seen from FIG. 2, bus lines 210 are shared buses between the processing channels. FIG. 1A shows some of the components that collectively form host system 180. Data streams are quantized into packets in order to make efficient use of system resources such as buffers and shared buses.

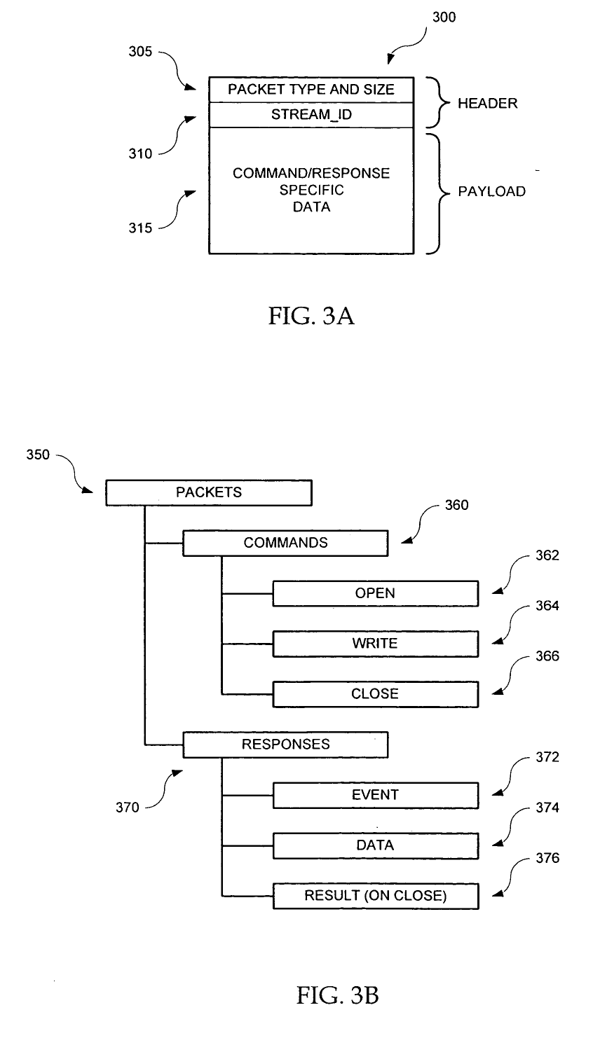

FIG. 3A shows one embodiment of a packet 300 carrying the data that content processing system 200 is adapted to process. Packet 300 contains a header field 305 that identifies, in part, the packet type and size 305, a stream ID 310 field that identifies the stream to which the packet belongs 310, a packet payload 315 that is in dependant of the packet type.

The content processing system 200 includes, in part, a multitude of parallel content processing channels (hereinafter alternatively referred to as channels) 215a, 215b, . . . , 215n. Each of these channels is adapted to implement one or more data extraction algorithms, such as HTTP content decoding; one or more data inspection algorithms, such as pattern matching; and one or more data classification algorithms, such as Bayes, used in spam e-mail detection. In some embodiments, different channels may implement the same or different processing algorithms. For example, in processing web contents, a relatively larger number of channels 215 may be configured to decode the contents in order to achieve high performance. In scanning files for viruses, decompression may be the bottleneck, therefore, a relatively larger number of channels 215 may be configured to perform decompressions. Thus, in accordance with the present invention, both the number of channels disposed in content processing system 200 as well as the algorithm(s) each of these channels is configured to perform may be varied.

Packets from the host system 180, alternatively referred to hereinbelow as command packets, arrive at the host interface 205 and are delivered as stored in one or more of the content processing channels 215 using shared bus 210. Content processing channels 215 may return information, such as to indicate that a match has occurred, to host interface 205 via bus 210.

A second bus 220 couples each of the content processing channels to a context manager 225. Bus 220 may or may not be directly coupled to first bus 210. Context manager 225 is configured to store and retrieve the context of any data it receives. This is referred to as context switching and allows interleaving of processing of a multitude of data streams by channels 215.

Host system 180 is configured to open each data stream using OPEN command 362, shown in FIG. 3B, prior to processing that data stream and delivering it to channels 215. The OPEN command 362 identifies the channels and the order in which the data from host system 180 is processed in accordance with the ID of the data stream. The OPEN command 362 further initializes each channel to prepare that channel for reception of data for a new stream. For example, opening a stream on an MD5 channel will initialize the hash registers to A=0x67452301, B=0xEFCDAB89, C=0x98BADCFE, and D=0x10325476, as defined by the MD5 algorithm and understood by those skilled in the art.

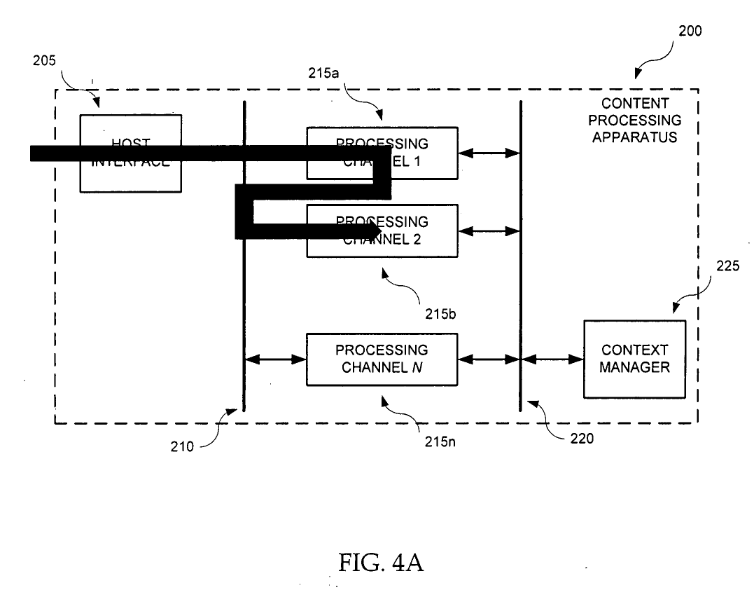

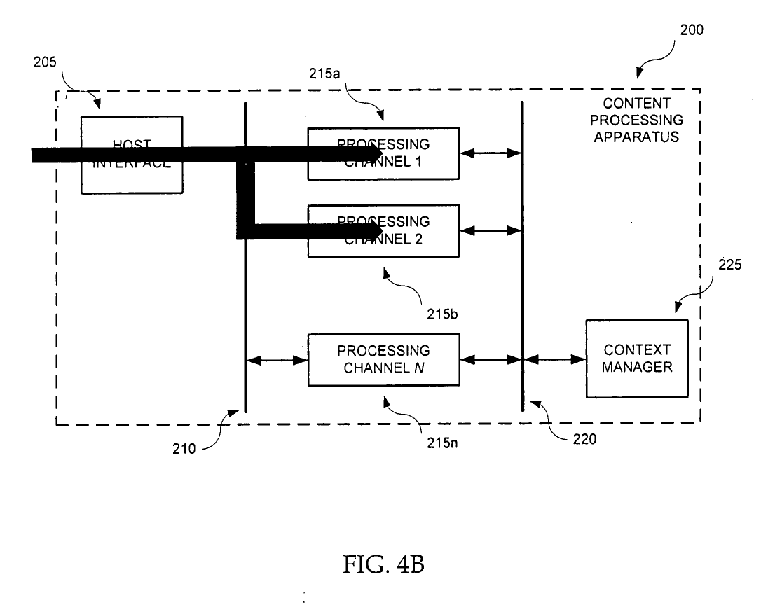

FIG. 4A shows sequential data processing between some of the channels 215 of the content processing system 200, in accordance with one exemplary embodiment of the present invention. In the exemplary embodiment shown in FIG. 4A in connection with an anti-virus application, the received data stream is first opened by channel 215a configured to decompress the received compressed data stream file and is subsequently opened by channel 215b configured to perform pattern matching on the received data. Therefore, data output by decompression channel 215a of FIG. 4A is processed by pattern matching channel 215b of FIG. 4A. In accordance with another embodiment, host interface 205 may only require access to the decompressed data and not require pattern matching. In such embodiments, the compressed file would only be opened on decompression channel 215a of FIG. 4A.

FIG. 4B shows a parallel data processing between some of the channels 215 of the content processing system 200, in accordance with another exemplary embodiment of the present invention. In the exemplary embodiment shown in FIG. 4B in connection with a data content integrity application, the file associated with the received data stream is opened on both the decompression channel 215a, and an MD5 hashing channel 215b. A hash algorithm, as known to those skilled in the art, is an algorithm which takes an arbitrary length sequence of bytes and produces a fixed length digest. The MD5 algorithm produces a 128-bit digest and is described by RFC1321 as defined by the Internet Engineering Task Force (IETF) and available on the World Wide Web at http://www.ieft.org/rfc/rfc1321.txt. Accordingly, in such embodiments, content processing system 200 decompresses the received file and provides an MD5 hash in parallel. The MD5 hash may be used to independently check the integrity of the received file.

In some embodiments, content processing system 200 decides on-the-fly where to send the data next through content analysis. For example, in one embodiment, e-mail messages are sent to one of the channels, e.g., 215a for processing. By analyzing the headers of the e-mail, channel 215a decides on-the-fly which decoding method is required, and therefore which channel should receive the data next.

Data to be processed by the multitude of channels 215 is sent to content processing 200 using WRITE command 364, (shown in FIG. 3B) by the host (not shown in FIG. 3B). As seen from FIGS. 3A and 3B, The WRITE command is included in the command field of the packet carrying the data payload. Since the packet header includes the stream ID for the data, content processing system 200 uses the information of the OPEN command to determine on which channels the data is to be processed. The received data is subsequently sent to these channels. When host system 180 determines to finish processing a data stream, host system 180 issues a CLOSE command 366, which in turn may trigger a response from the processing channels 215. For example, the issuance of CLOSE command may trigger one or more of the processing channels 215 to compute an MD5 hash.

Content processing channels 215 generate response packets 370 in response to commands they receive. Some channels, such as channels configured to perform pattern matching, generate one or more fixed sized packets, shown in FIG. 3B as event packets 372, if a match exists in the data being processed. These packets have well defined fields that can be interpreted by the host system or other processing channels. Some channels, such as channels performing data extraction or decompression, generate one or more variable size data packets, shown in FIG. 3B as data packets 374. Some other channels, such as channels implementing hashing algorithms like MD5, are configured to generate an output only when the stream is closed, shown in FIG. 3B as result packets 376, and described further below.

The foregoing discussion of packets is summarized by the following syntax, which may be readily translated into software instructions to be executed by host processor 180, as known by those skilled in the art.

OPEN(<stream id>, <channel configuration>)
WRITE(<stream id>, <data>)
CLOSE(<stream id>)
EVENT {<stream id>, <event type>, <event data>}
DATA {<stream id>, <data>}
RESULT {<stream id>, <result type>, <result data>}

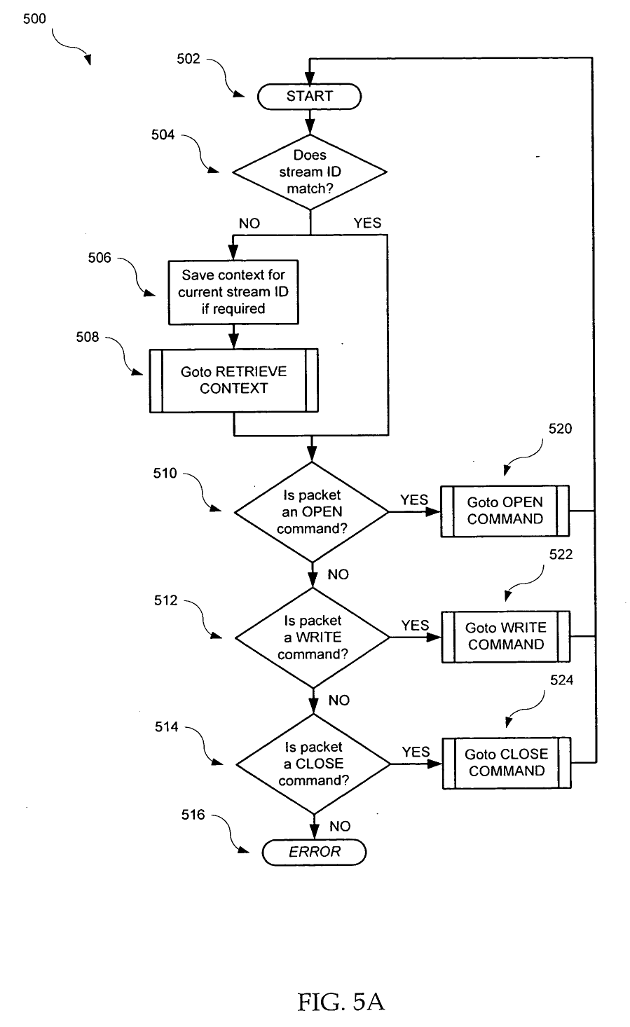

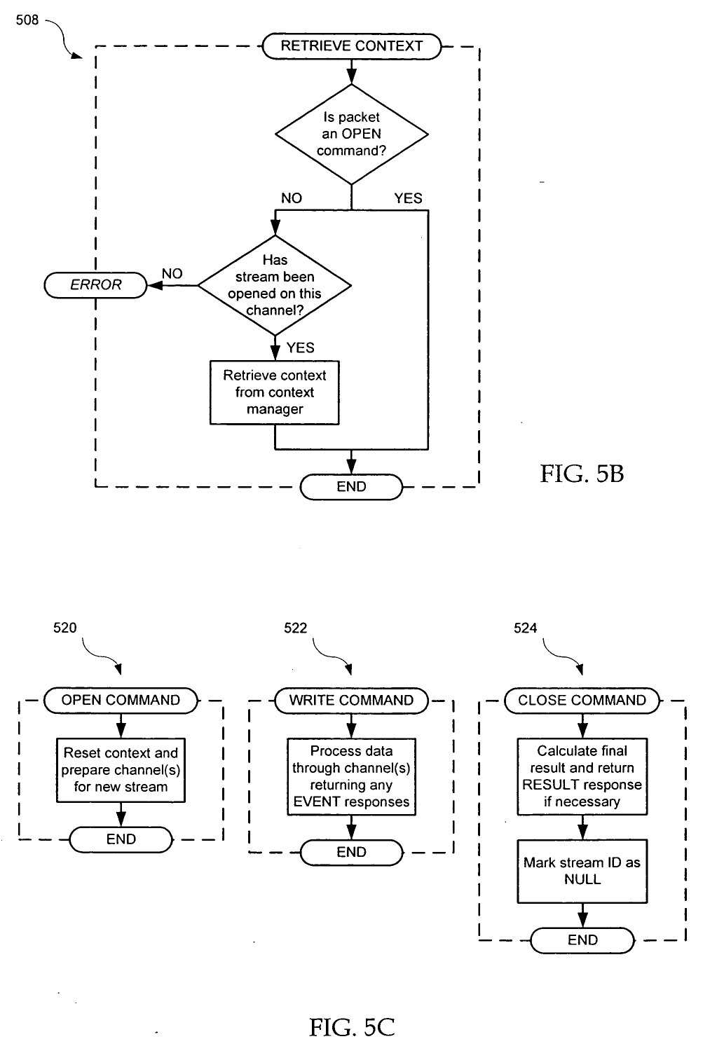

In accordance with the present invention, content processing system 200 is configured to process multiple data streams concurrently and maintain high throughput. FIG. 5A is a flowchart 500 of steps performed by content processing system 200, in accordance with one embodiment of the present invention. At step 502 packets, such as packet 300, carrying the data stream are received by host interface 205. Next, at step 504 the channel which receives the packet from host interface 205, compares the stream_id field 310 of the packet with that of the currently opened stream for the channel. If there is a mismatch, at step 506, any state information associated with that channel and stream is saved by context manager 225. Next, at step 508 a previous context is retrieved from context manager 255. If at step 504 a match is found, no context information is saved or retrieved. At steps 510, 512, and 514 content processing system 200 determines whether the command received by the channel via the host interface is an open command, a write command, or a close command, respectively, by checking the packet_type field 305 of the received packet. Each received packet is subsequently processed in accordance with its type, as illustrated in FIG. 5C.

If a context switch is required, during step 508, the content processing system 200, in accordance with one embodiment of the present invention, proceeds as defined in flowchart 508 in FIG. 5B. The context switch first identifies whether the packet is an open command during step 552. If the packet is identified as an open command packet, the process moves to step 560 to end the context retrieval. If during step 552, the packet is not identified as an open command packet, process moves to step 554 at which step determination is made as to whether stream has been opened on the channel. If it is determined that a stream has not been opened on the channel, an error message is generated at step 556 since no context needs to be retrieved. If it is determined that a stream has been opened on the channel, the context manager checks for the presence of valid context information and retrieves the context at step 558.

FIG. 5C shows flowcharts 520, 522, and 524 associated respectively with processing of open, write and close commands, in accordance with embodiment of the present invention. As seen from flowchart 520, after receiving an OPEN command, the context is reset and the channel(s) are prepared for new stream, after which the OPEN command is ended. As seen from flowchart 530, after receiving an OPEN command, the context is reset and the channel(s) are prepared for new stream, after which the OPEN command is ended. As seen from flowchart 522, after receiving a WRITE command, the data is processed through the channel(s). Any EVENT responses that may have been generated as a result of processing the data is returned, after which the WRITE command is ended. As seen from flowchart 524, after receiving a CLOSE command, final results are calculated and any necessary final result is returned. Thereafter, the stream is marked as NULL, and the CLOSE command is ended.

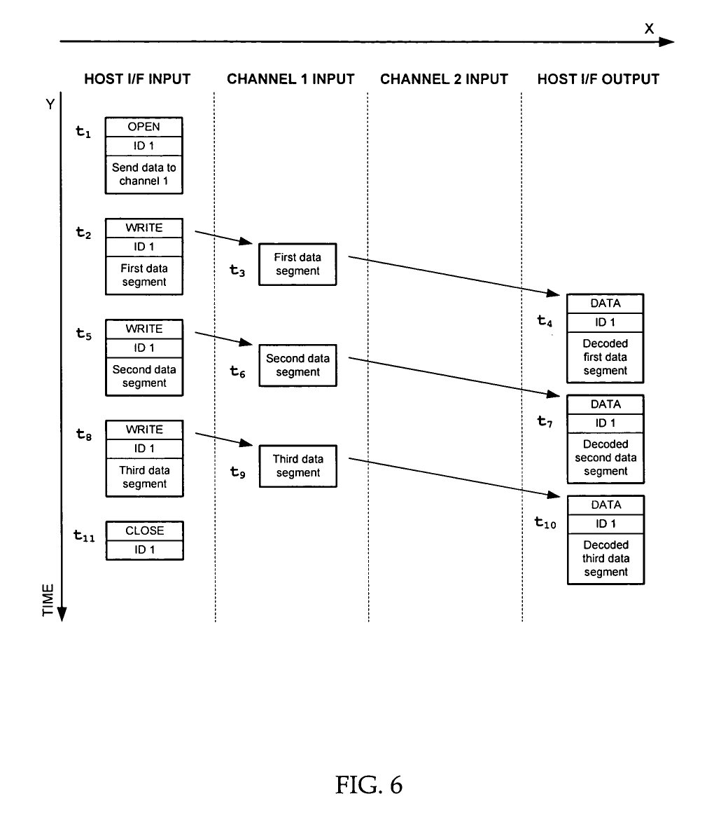

Each of FIGS. 6-11 provides an exemplary data flow among various blocks of content processing system 200, as described above in flowchart 500. In FIGS. 6-11, it is assumed that channel 1 corresponds to one of the channels 215 in FIG. 2A and is configured to decode content, and channel 2 corresponds to another one of channels 215 in FIG. 2A and is configured to perform pattern matching. For purposes of simplicity, not all the steps of flowchart 500 are shown in the following FIGS. 6-11.

Exemplary data flow, shown in FIG. 6, shows the processing of a data stream on a single channel, marked along the x-axis, as a function of time, marked along the y-axis. The data stream is divided into a series of segments, each segment being small enough to fit into a data packet 300 for processing by the apparatus disclosed herein. At time t1, host interface 205 (see FIG. 2) receives via its input terminals a packet carrying data stream with stream_id field of 1. Using an open command, this data stream is opened on the designated channel. Next, at time t2, a first data segment is written for processing using the write command. At time t3, this first data segment is delivered to channel 1 for, e.g., decoding. At time t4, channel 1 delivers a response packet containing the, e.g., decoded data to the to host interface 205 to be transferred to host processor 180. Next, at time t5, a second data segment is written for processing using the write command. At time t6, this second data segment is delivered to channel 1 for decoding. At time t7, channel 1 delivers another response packet containing the decoded data of the second data segment to the to host interface 205 to be transferred to host processor 180. At time t8, a third data segment is written for processing using the write command. At time t9 this third data segment is delivered to channel 1 for decoding. At time t10, channel 1 delivers another response packet containing the decoded data of the third data segment to the to host interface 205 to be transferred to host processor 180. At time t11 host interface 205 closes the incoming data stream. It is understood that the host closes a channel when all the data for a given data stream has been processed, or when the host determines that processing can be stopped early, such as upon detection of a virus within an email attachment. Decoded data can be reassembled into a contiguous data stream from packets at times t4, t7, and t10.

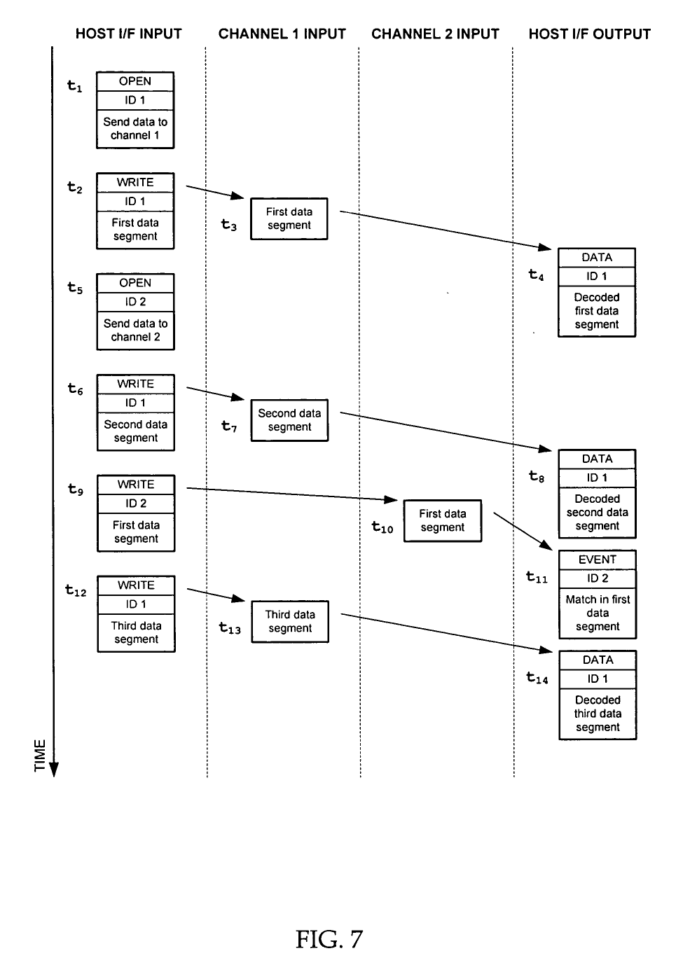

Exemplary data flow, shown in FIG. 7, shows the processing of two different data streams associated with two separate channels as a function of time. Since the two streams do not share channels, data processing is carried out in parallel. At time t1, host interface 205 receives via its input terminals a packet carrying data stream with stream_id field of 1. Using an open command, this data stream is opened. Next, at time t2, a first data segment of this data stream is written for processing using the write command. At time t3, this first data segment is delivered to channel 1 for, e.g., decoding. At time t4, channel 1 delivers a response packet containing the, e.g., decoded data to the to host interface 205 to be transferred to host processor 180. Next, at time t5, host interface 205 receives and opens a packet carrying a second data stream with stream_id field of 2. At time t6, a second data segment of the first data stream is written for processing using the write command. At time t7, the second data segment of the first data stream is delivered to channel 1 for decoding. At time t8, channel 1 delivers another response packet containing the decoded data of the second data segment of the first data stream to the to host interface 205. At time t9, a first data segment of the second data stream is written for processing using the write command. At time t10 the first data segment of the second data stream is delivered to channel 2 for, e.g., pattern matching. At time t11, channel 2 delivers a response packet containing, e.g., the result of the pattern matching to the host interface 205 to be transferred to host processor 180. At time t12, a third data segment of the first data stream is written for processing using the write command. At time t7, the second data segment of the first data stream is delivered to channel 1 for decoding. At time t13, the third data segment of the first data stream is delivered to channel 1 for decoding. At time t14 channel 1 delivers another response packet containing the decoded data of the third data segment of the first data stream to the to host interface 205. Although not depicted in FIG. 7, the streams are finally closed by issuing the close command as illustrated in FIG. 6.

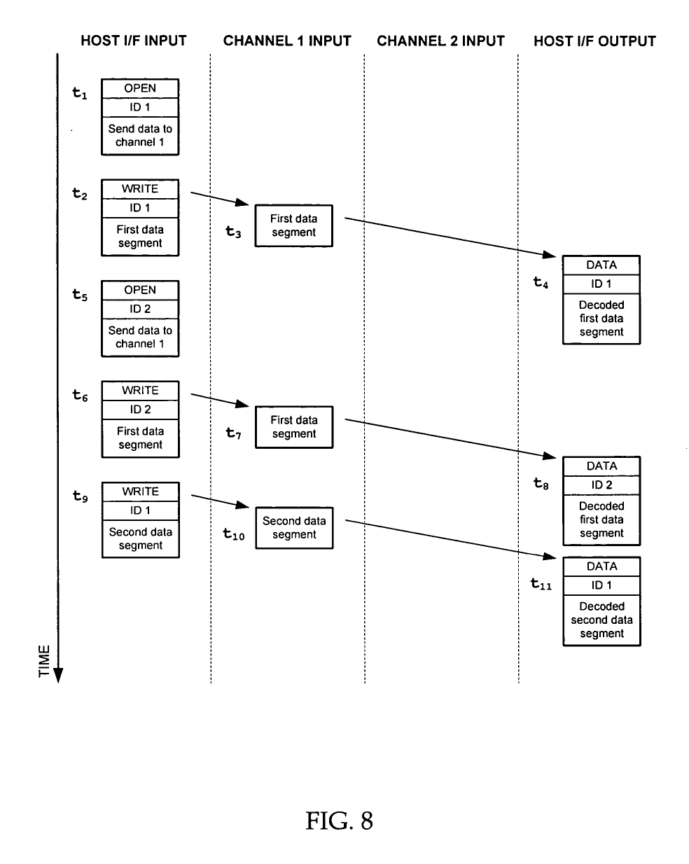

Exemplary data flow, shown in FIG. 8, shows the processing of two different data streams on the same channel. At time t1 a first data stream having stream_id field of 1 is opened, using the open command. Next, at time t2, a first data segment of this data stream is written for processing using the write command. At time t3, this first data segment is delivered to channel 1 for, e.g., decoding. At time t4, channel 1 delivers a response packet containing the, e.g., decoded data to the to host interface 205 to be transferred to host processor 180. Next, at time t5 a second stream having stream_id field of 2 is opened while the first data stream remains open. This causes the context for the first data stream to be saved, as is shown in flow chart 500 of FIG. 5 Next, at time t6, a first data segment of the second data stream is written for processing using the write command. At time t7, the first data segment of the second data stream is delivered to channel 1. At time t8, channel 1 delivers a response packet containing the decoded data of the first segment of the second data stream to host interface 205 to be transferred to host processor 180. This triggers the context for the second stream to be saved and the context for the first stream to be restored as indicated by the flow chart 500 of FIG. 5. At time t9, a second data segment of the first data stream is written for processing using the write command. At time t10, the second data segment of the first data stream is delivered to channel 1. At time t11, channel 1 delivers a response packet containing the decoded data of the second segment of the first data stream to host interface 205 to be transferred to host processor 180.

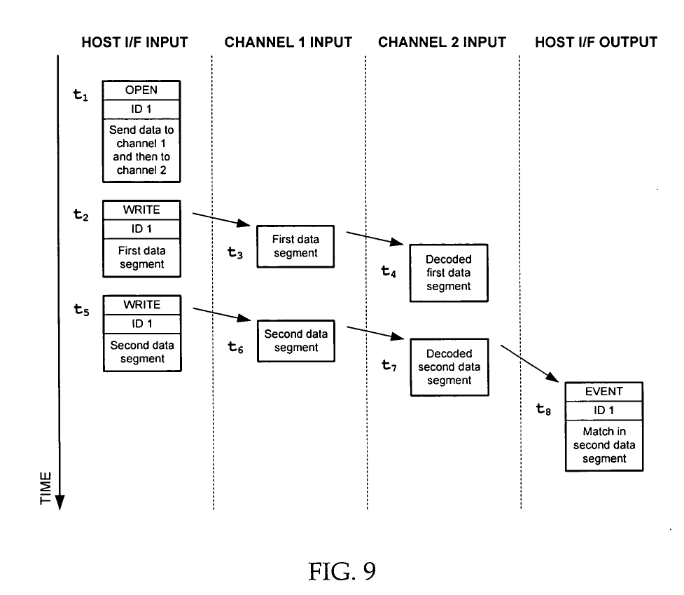

Exemplary data flow, shown in FIG. 9, shows the processing in series of a data stream by two channels 1 and 2. The data processed, e.g. decoded, by the first channel is passed to the second channel for further processing, e.g. for pattern matching. At time t1 the data stream having stream_id field of 1 is opened, using the open command. Next, at time t2, a first data segment of this data stream is written for processing using the write command. At time t3, this first data segment is delivered to channel 1 for, e.g., decoding. At time t4, channel 1 delivers a response packet containing the decoded first data segment to channel 2 for, e.g., pattern matching. In this exemplary data flow, it is assumed that no match is found in the first data segment. Next, at time t5, a first data segment of the data stream is written for processing using the write command. At time t6, this second data segment is delivered to channel 1 for decoding. At time t7, channel 1 delivers a response packet containing the decoded second data segment to channel 2 for pattern matching. At time t8, channel 2 sends an event packet to host interface 205 indicating that, e.g., a match is found in the second data segment. It is understood that field 305, i.e., packet type and size, indicates how much data is in a single packet. A data stream is divided into a number of smaller packets, and the host is adapted to identify the end of the stream is left to the host. The host indicates the end of a stream by issuing a CLOSE command 366.

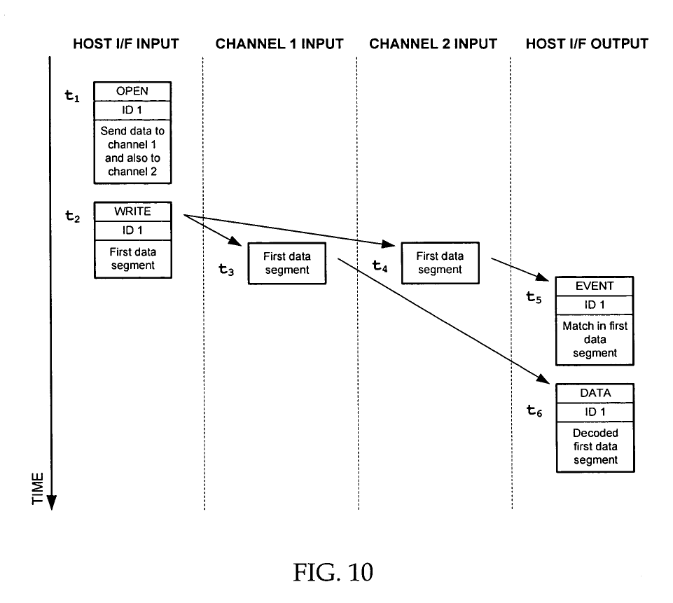

Exemplary data flow, shown in FIG. 10, shows the processing of a single data stream by multiple channels in parallel. The data written from the host processor is passed to both channel 1 and channel 2 for processing. These two channels process the data independently in parallel and return their responses to the host system. At time t1 the data stream having stream_id field of 1 is opened, using the open command. Next, at time t2, a first data segment of this data stream is written for processing using the write command. At time t3, this first data segment is delivered to both channels 1 and 2. for, e.g., decoding and pattern matching respectively. At time t4, channel 2 delivers an event packet to host interface 205 indicating that, e.g., a match is found in the data segment. At time t5, channel 1 sends a response packet containing the decoded data segment to host interface 205. It is understood that, in the preceding exemplary data flow, the output of a channel may be written to multiple channels in the same way data from the host may be written to multiple channels. For example, a decoding channel, such as a Base64 decoder, may have its output redirected to a first channel performing pattern matching and to a second channel performing MD5 hashing.

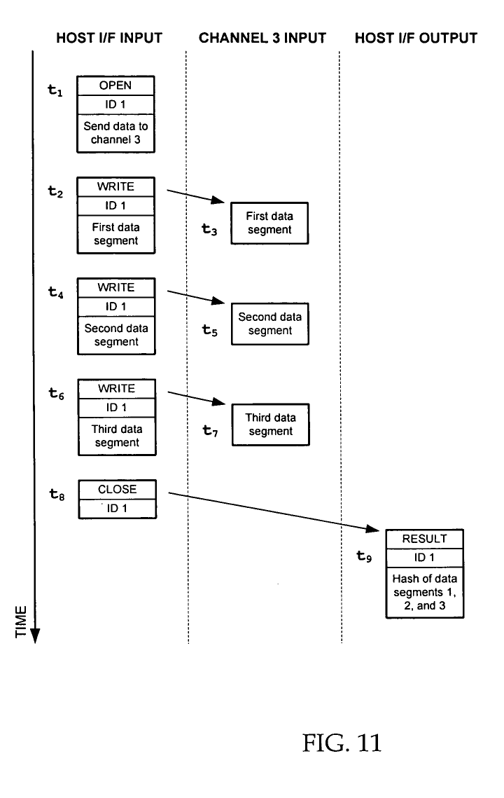

Exemplary data flow, shown in FIG. 11, shows the processing of a single data stream through a single channel, namely channel 3, that is configured to generate a result when the channel is closed. Channel 3 is assumed to be a message digesting channel, such as MD5. At time t1 the data stream having stream_id field of 1 is opened, using the open command. At time t2, a first data segment of this data stream is written for processing using the write command. At time t3, this first data segment is processed so as to update the current state of the message digest. At time t4, a second data segment of this data stream is written for processing using the write command. At time t5, this second data segment is processed. At time t6, a third data segment of this data stream is written for processing using the write command. At time t7, this second data segment is processed. It is understood that as various data segments are written to channel 3, the internal state of channel 3 is updated by processing of that data. At time t8, channel 3 is closed to indicate that all data has been written. This causes channel 3 to compute the final result, at time t9, and send a result packet 376 that contains, e.g., the MD5 hash of the first, second and third data segments, as well as any padding of the data as may be required, to host interface 205.

In accordance with the present invention, and as described above, because the various channels disposed in content processing 200—each of which may be optimized to perform a specific function, such as content decoding or pattern matching—are adapted to form a processing chain, the data flow is achieved without any intervention from the host processor, so as to enable the host processor to perform other functions to increase performance and throughput. Additionally, because multiple channels may operate concurrently to process the data—the data is transferred from the host system via host interface 205—only once from the host—savings in both memory bandwidth host CPU cycles is achieved.

Furthermore, in accordance with the present invention, because the host system may have multiple data streams open at the same time, with each data stream sent to one or more channels for processing as it is received, the channels and the context manager are configured to maintain the state of each data stream, thereby alleviating the task of data scheduling and data pipelining from the host system. Moreover, because each channel, regardless of the functions and algorithm that that channel is adapted to perform, responds to the same command set, and operates on the same data structures, each channel may send the data to any other channel, and enables the content processing system of the present invention to be readily extensible.

The above embodiments of the present invention are illustrative and not limiting. Various alternatives and equivalents are possible. The invention is not limited by any commands, namely commands open, write, and close, as well as response packets event, data, and result are only illustrative and not limitative. For example, some embodiments of the present invention may further be configured to implement a marker command adapted to initiate the targeted channel to respond with a mark response packet operative to notify the host processor that processing has proceeded to a certain point in the data stream. Other command and response, whether in the packet form or not, are within the scope of the present invention. The invention is not limited by the type of integrated circuit in which the present invention may be disposed. Nor is the invention limited to any specific type of process technology, e.g., CMOS, Bipolar, or BICMOS that may be used to manufacture the present invention. Other additions, subtractions or modifications are obvious in view of the present invention and are intended to fall within the scope of the appended claims

What is claimed is:

1. A system configured to process content data received via a network or filesystem, the system comprising:
a host interface configured to establish communication between the system and a host external to the system;
a plurality of content processing channels each configured to perform one or more processing algorithms on the data received from the host interface;
a context manager configured to store and retrieve the context of data received from the plurality of content processing channels; and
at least one bus having a plurality of bus lines, the plurality of bus lines coupling the context manager to the plurality of content processing channels, the plurality of bus lines further coupling the host interface to the plurality of content processing channels.

2. The system of claim 1 wherein each of the plurality of channels is configured to perform one or more processing algorithms selected from the group consisting of literal string matching, regular expression matching, pattern matching, MIME message decoding, HTTP decoding, XML decoding, content decoding, decompression, decryption, hashing, and classification.

3. The system of claim 1 wherein the host interface is further configured to receive commands from the host.

4. The system of claim 1 wherein the host interface is further configured to send responses to the host.

5. The system of claim 1 wherein each of the plurality of content processing channels is configured on-the-fly.

6. The system of claim 1 wherein the plurality of content processing channels are configured to perform the processing algorithms in parallel.

7. The system of claim 1 wherein the plurality of content processing channels are configured to perform the processing algorithms in series.

8. The system of claim 1 wherein each of the plurality of content processing channels is adapted to be reprogrammed to perform different processing algorithms.

9. The system of claim 1 wherein data communicated between the host and the system via the host interface is quantized into discrete packets

10. A method of processing content of data received via a network, the method comprising:
receiving the data from a host via a host interface;
performing one or more processing algorithms on the data using a plurality of content processing channels;
storing the context received from the plurality of content processing channels;
retrieving the context received from the plurality of content processing channels.

11. The method of claim 10 wherein each processing algorithm is selected from the group consisting of literal string matching, regular expression matching, pattern matching, MIME message decoding, HTTP decoding, XML decoding, content decoding, decompression, decryption, hashing, and classification.

12. The method of claim 10 further comprising:
receiving commands from the host.

13. The method of claim 10 further comprising:
sending responses to the host.

14. The method of claim 10 further comprising:
configuring each of the plurality of content processing channels on-the-fly.

15. The method of claim 10 wherein the plurality of content processing channels perform one or more processing algorithms in parallel.

16. The method of claim 10 wherein the plurality of content processing channels perform one or more processing algorithms in series.

17. The method of claim 10 wherein each of the plurality of content processing channels is adapted to be reprogrammed to perform different processing algorithms.
